(19) United States
(12) Patent Application Publication
(10) Pub. No.: US 2024/0239274 A1
(43) Pub. Date: Jul. 18, 2024

(54) SIDE LINING FOR A VEHICLE

(71) Applicant: Honda Motor Co., Ltd., Tokyo (JP)

(72) Inventors: Eric M. Daulton, Marysville, OH (US); Ryan W. Van Voorhis, Powell, OH (US); John F Howard, JR., Marysville, OH (US)

(21) Appl. No.: 18/154,649

(22) Filed: Jan. 13, 2023

(51) Int. Cl. B60R 13/02; B60N 2/01; B60N 2/20

(52) U.S. Cl. CPC B60R 13/0237; B60N 2/01; B60N 2/20

(57) ABSTRACT

A side lining adapted to be mounted to a sidewall of a vehicle includes a step structure defining a step surface extending horizontally and inside a passenger compartment of the vehicle. The step surface is arranged proximate to a bottom end of the side lining and defines a load surface to support a cargo.

### BACKGROUND

The disclosed subject matter relates generally to vehicles. More particularly, the disclosed subject matter relates a vehicle having rear seats adapted to be moved to a folded position.

Vehicles 10, shown in FIG. 1, such as, minivans, typically includes three rows of seats and the seats 12 of the rearmost row can be folded to extend a cargo space 14 of the vehicle 10 to accommodate relatively a wide cargo 16. However, during loading of the wide cargo 16 inside the cargo space 14, the cargo 16, generally, may entangle with the carpet and the fabric of the folded seats 12, hindering the loading and positioning of the cargo 16 inside the vehicle 10, which is undesirable.

### SUMMARY

In accordance with one embodiment of the present disclosure, a side lining for a vehicle is disclosed. The side lining is adapted to be mounted to a sidewall of the vehicle and includes a step structure defining a step surface extending horizontally and inside a passenger compartment of the vehicle. The step surface is arranged proximate to a bottom end of the side lining and defines a load surface to support a cargo.

In accordance with another embodiment of the present disclosure, a vehicle is provided. The vehicle includes a vehicle body defining a passenger compartment and a cargo area. The vehicle further includes a side lining mounted on a sidewall of the vehicle body and extending from a rear end of the vehicle towards a front end of the vehicle. The side lining defines a step surface extending horizontally and inside the passenger compartment of the vehicle. The step surface is arranged proximate to a bottom end of the side lining and defines a load surface to support a cargo arranged inside the cargo area.

In accordance with yet a further embodiment of the present disclosure a side lining for a vehicle is disclosed. The side lining is adapted to be mounted to a sidewall of the vehicle and includes a first step structure defining a first step surface portion surface extending horizontally and inside a passenger compartment of the vehicle. The first step surface portion is arranged proximate to a first longitudinal end of the side lining. The side lining also includes a second step structure defining a second step surface portion extending horizontally and inside the passenger compartment of the vehicle. The second step surface portion is arranged proximate to a rear end of the vehicle and is separated from the first step structure by a gap. The first step surface portion and the second step surface portion are arranged proximate to a bottom end of the side lining and together define a load surface to support a cargo.

### BRIEF DESCRIPTION OF THE DRAWINGS

Certain embodiments of the present disclosure will be better understood from the following description taken in conjunction with the accompanying drawings in which:

FIG. 1 is an inside view of a vehicle depicting an interference between a cargo and a seat fabric while loading the cargo inside a cargo area of the vehicle;

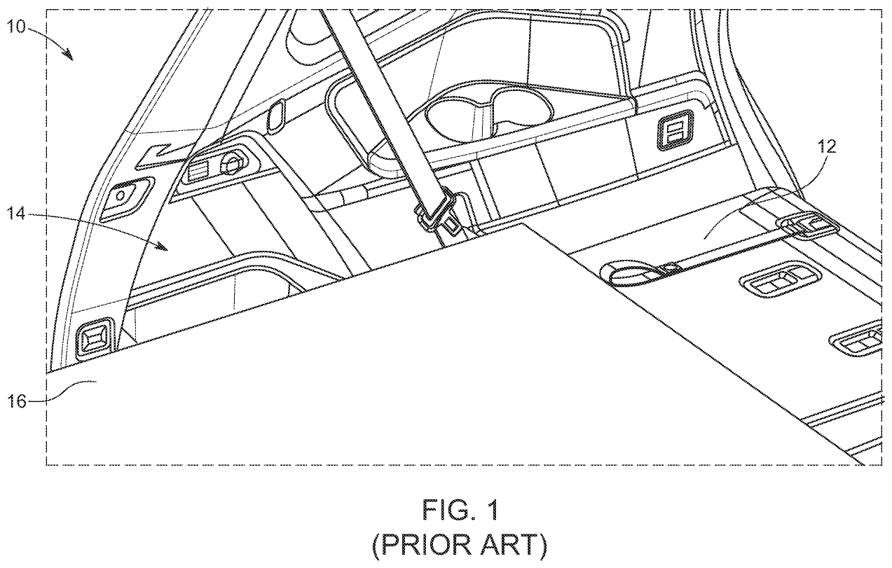

FIG. 2 is a front perspective view of a vehicle, in accordance with one embodiment of the present disclosure;

FIG. 3 is a side perspective view of the vehicle with one longitudinal side removed and depicting a plurality of seats arranged in a plurality rows, in accordance with one embodiment of the present disclosure; and

FIG. 4 is a rear perspective view of the vehicle depicting a cargo area of the vehicle and one or more seats of a rear row arranged in an upright position, in accordance with one embodiment of the present disclosure;

FIG. 5 is a side perspective view of a side lining removed from the vehicle, in accordance with one embodiment of the present disclosure;

FIG. 6 is a side view of the side lining with a cargo arranged on a step surface of the side lining, in accordance with one embodiment of the present disclosure; and

FIG. 7 is a sectional view depicting a vertical gap between an upper surface of the rear seat arranged in a folded position and the cargo arranged on the step surface of the side lining, in accordance with one embodiment of the present disclosure.

### DETAILED DESCRIPTION OF EXEMPLARY EMBODIMENTS

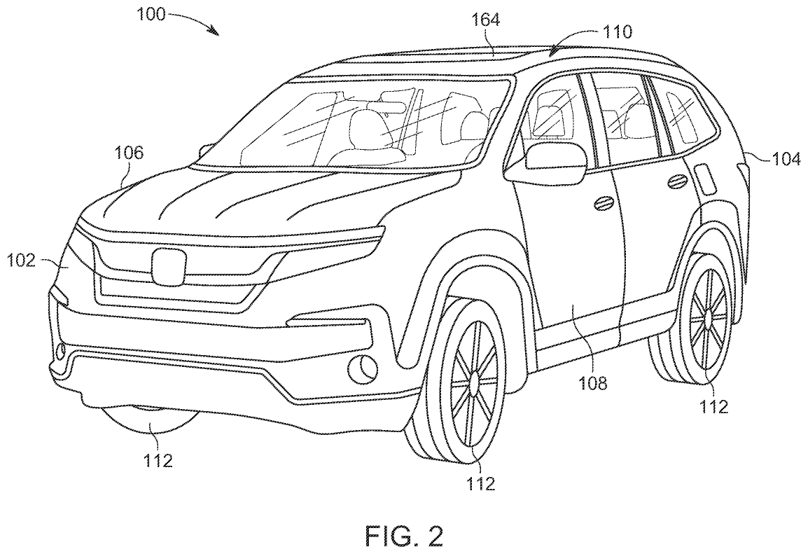

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows. Embodiments are hereinafter described in detail in connection with the views and examples of FIGS. 2-7, wherein like numbers indicate the same or corresponding elements throughout the views.

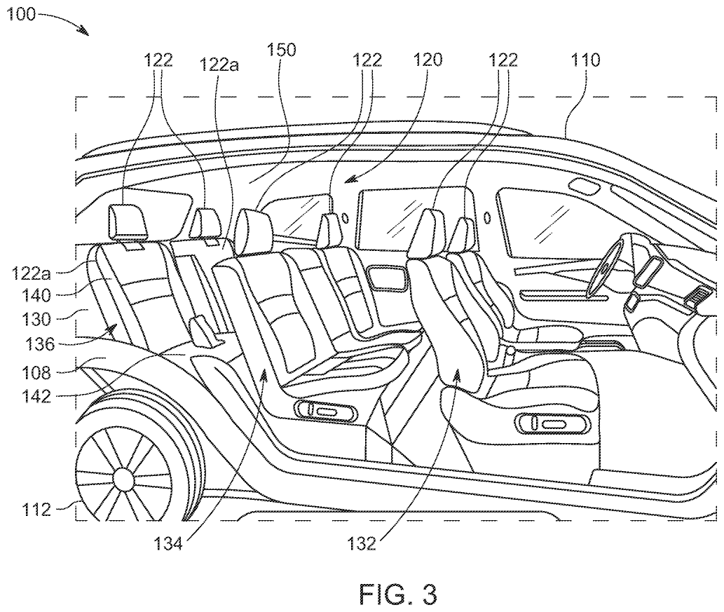

FIG. 2 illustrates a front perspective view of a vehicle, indicated generally at 100, in accordance with one embodiment of the present disclosure. Referring to FIGS. 2 and 3, the vehicle 100 is shown as a minivan having 3 rows of seats. However, the vehicles 100 in accordance with alternative embodiments can comprise any variety of vehicles, including hatchbacks, multi-utility vehicles, sport utility vehicles, jeeps, truck, etc., for example.

The vehicle 100 includes a front end 102, a rear end 104, a first longitudinal side 106 (hereinafter referred to as a left side 106), a second longitudinal side 108 (hereinafter referred to as a right side 108), and a vehicle body 110 extending from the front end 102 to the rear end 104 and supported on a plurality of wheels 112. As shown in FIG. 3, the vehicle body 110 defines a passenger compartment 120 having a plurality of seats 122 to facilitate a seating of a plurality of passengers including a driver inside the vehicle 100, and a cargo area 130 arranged at a rear of the vehicle body 110 to enable a storage of one or more cargo inside the vehicle 100. In the illustrated embodiment, the plurality of seats 122 is arranged in a plurality of rows, for example, a first row 132 (i.e., a front row 132), a second row 134 (i.e., middle row 134), and a third row 136 (i.e., a rear row 136), extending in a lateral direction of the vehicle 100.

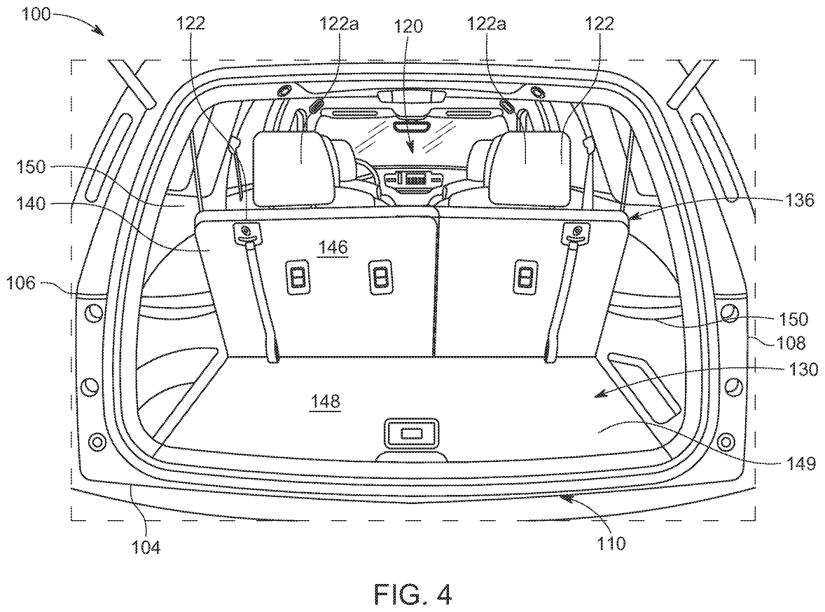

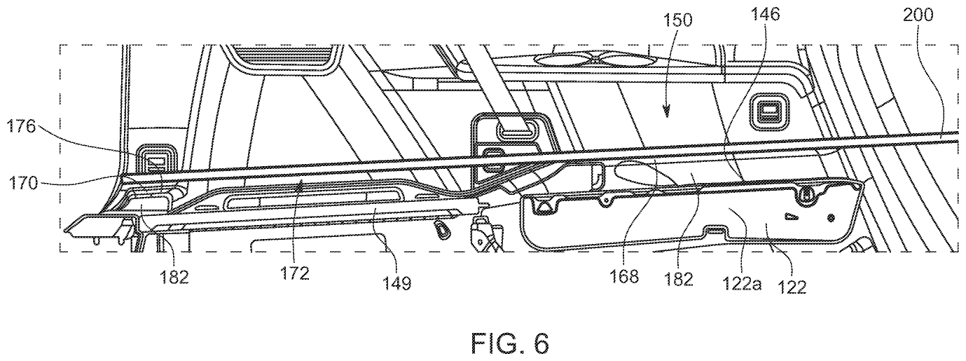

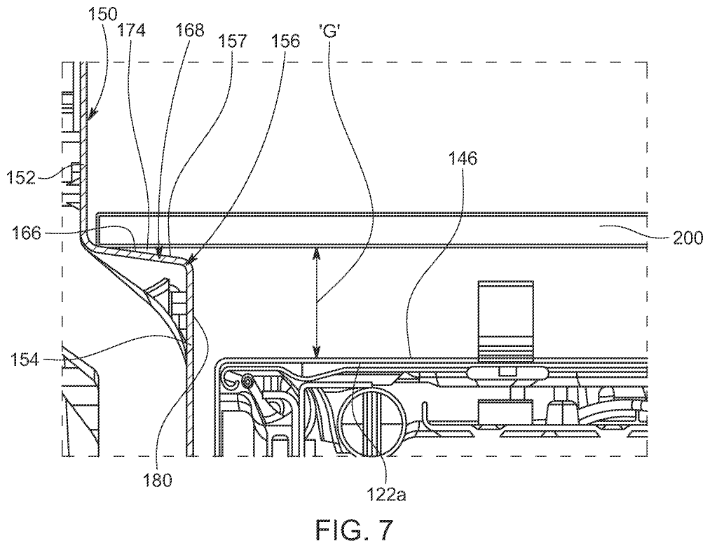

Further, one or more seats 122a of the rear row 136 is configured to be arranged in a raised position (i.e., upright position) (shown in FIGS. 3 and 4) and a folded position (shown in FIGS. 6 and 7). In the raised position, a backrest 140 of the seat 122a extends in a vertical direction to enable a seating of the passenger on the seat 122a, while in the folded position, the backrest 140 is disposed in a substantially horizontal position, facing a seat member 142 of the seat 122a. Also, as shown in FIGS. 6 and 7, the seats 122a of the rear row 136 are configured/structured such that in the folded position, a rear surface 146 of the backrest 140 of the seats 122a are arranged substantially flush with an upper surface 148 of a floor 149 of the cargo area 130. One or more seats 122a of the rear row 136 are moved to the folded position to extend the cargo area 130 of the vehicle 100 to enable a loading/storage of cargo having relatively longer lengths, for example, boards.

Moreover, as shown in FIG. 4, the vehicle 100 includes a pair of side linings 150 arranged inside the vehicle 100 and connected to inner surfaces of the sidewalls 152 and/or the doors of the vehicle body 110. The side linings 150 extend in the longitudinal direction and are arranged on the opposite longitudinal sides 106, 108 of the vehicle 100. The side linings 150 are identical in structure, construction, and assembly, and therefore, for the sake of clarity and brevity, a structure, construction, and an assembly of only one side lining 150 that is arranged on the first longitudinal side 106 is explained.

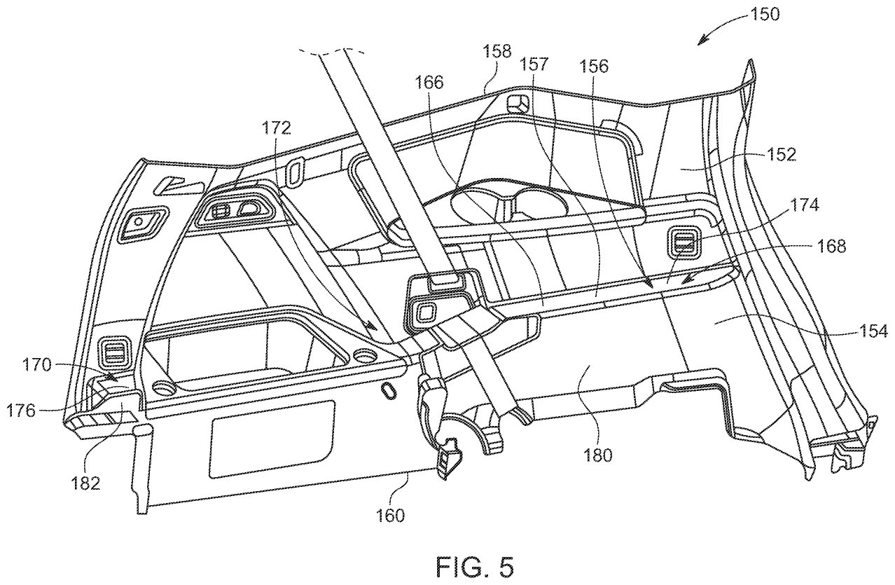

As shown in FIG. 6, the side lining 150 extends from the rear end 104 of the vehicle body 110 towards a front end 102, and extends along a portion of the first longitudinal side 106 that is arranged proximate to the rear row 136 of seat 122a. In an embodiment, as best shown in FIG. 5, the side lining 150 includes a first portion 152 and a second portion 154, the first portion 152 extends from a top end 158 of the side lining 150 to the second portion 154, while the second portion 154 may extend from first portion 152 to a bottom end 160 of the side lining 150. As shown, at least a part/portion of the second portion 154 extend outwardly of the first portion 152, inside the passenger compartment 120, in the lateral direction, thereby providing/defining the step structure 156 having a step surface 157 that is arranged facing a roof 164 of the vehicle 100. In an embodiment, the step surface 157 defines a load surface 166 of the cargo area 130 and is configured to support the cargo arranged inside the cargo area 130.

In an embodiment, the step structure 156 includes two step structures, for example, a first step structure 168 (i.e., front step structure 168) and a second step structure 170 (i.e., rear step structure 170) separated by a gap 172. The first step structure 168 defines a first step surface portion 174 of the step surface 157, while the second step structure 170 defines a second step surface portion 176 of the step surface 157. In an embodiment, the first step surface portion 174 and the second step surface portion 176 are disposed horizontally aligned with each other.

Moreover, as shown, the step structure 156 extends in a longitudinal direction from the rear end 104 of the vehicle 100 towards the front end 102 such that the first step structure 168 (i.e., the first step surface portion 174) is arranged proximate to a front end (i.e., a first longitudinal end) of the side lining 150 and may be arranged proximate/adjacent to the rear seats 122a, while the second step structure 170 (i.e., the second step surface portion 176) is arranged proximate to a rear end of the side lining 150. Accordingly, the second step structure 170 is arranged proximate to the rear end 104 of the vehicle 100. Although the step structure 156 is shown to include two step structures 168, 170 separated by the gap 172, it may be appreciated that the step structure 156 may include a single step structure extending in the longitudinal direction of the vehicle 100. As shown, the step surface 157 is arranged proximate to the floor 149 of the vehicle 100 and is disposed horizontally to support the cargo.

Additionally, as shown in FIGS. 5 and 6, each of the first and second step structures 168, 170 includes a vertically extending sidewall 180, 182 that extend downwardly from the associated horizontally arranged side surface to support the load of the cargo 200. Accordingly. the side structures 168, 170 of the side linings 150 supports the cargo at a location above the floor 149 of the cargo area 130 as well as the rear surface 146 of the rear seats 122a when the rear seats 122a the arranged in the folded position, as shown in FIGS. 6 and 7. Therefore, the step structures 168, 170, (i.e., the first and second step surface portions 174, 176) and hence the step structure 156 (i.e., the step surface 157) facilitates in keeping wide wide cargo, such as, 4 feet wide standard sized sheet of plywood, during loading, above the floor 149 and the rear surface of the rear seat 122a, preventing an interference of the cargo 200 with a carpet arranged on the upper surface 148 and/or fabric of the rear seats 122a.

The foregoing description of embodiments and examples has been presented for purposes of illustration and description. It is not intended to be exhaustive or to limit the invention to the forms described. Numerous modifications are possible in light of the above teachings. Some of those modifications have been discussed and others will be understood by those skilled in the art. The embodiments were chosen and described in order to best illustrate certain principles and various embodiments as are suited to the particular use contemplated. The scope of the invention is, of course, not limited to the examples or embodiments set forth herein, but can be employed in any number of applications and equivalent devices by those of ordinary skill in the art. Rather it is hereby intended the scope of the invention be defined by the claims appended hereto.

What is claimed is:

1. A side lining for a vehicle and adapted to be mounted to a sidewall of the vehicle, the side lining comprising:
a step structure defining a step surface extending horizontally and inside a passenger compartment of the vehicle, wherein the step surface is arranged proximate to a bottom end of the side lining and defines a load surface to support a cargo.

2. The side lining of claim 1, wherein the side lining is configured to extend from a rear end of the vehicle towards a front end of the vehicle.

3. The side lining of claim 1, wherein the step structure includes
a first step structure defining a first step surface portion of the step surface and arranged proximate to a first longitudinal end of the side lining, and
a second step structure defining a second step surface portion of the step surface and arranged proximate to a rear end of the vehicle and separated from the first step structure by a gap.

4. The side lining of claim 3, wherein the first step surface portion aligns horizontally with the second step surface portion.

5. The side lining of claim 1, wherein the step structure includes a sidewall extending vertically towards the bottom end of the side lining from the step surface.

6. The side lining of claim 1, wherein the vehicle includes one or more seats adapted to be arranged in an upright position and a folded position, wherein the step surface is adapted to be arranged at a vertical gap from a surface of the one or more seats arranged in the folded position.

7. A vehicle, comprising:
a vehicle body defining a passenger compartment and a cargo area; and
a side lining mounted on a sidewall of the vehicle body and extending from a rear end of the vehicle towards a front end of the vehicle, the side lining defines
a step surface extending horizontally and inside the passenger compartment of the vehicle, wherein the step surface is arranged proximate to a bottom end of the side lining and defines a load surface to support a cargo arranged inside the cargo area.

8. The vehicle of claim 7, wherein the side lining includes a step structure that defines the step surface of the side lining.

9. The vehicle of claim 8, wherein the step structure includes
a first step structure defining a first step surface portion of the step surface and arranged proximate to a first longitudinal end of the side lining, and
a second step structure defining a step second surface portion of the step surface and arranged proximate to a rear end of the vehicle and separated from the first step structure by a gap.

10. The vehicle of claim 9, wherein the first step surface portion aligns horizontally with the second step surface portion.

11. The vehicle of claim 8, wherein the step structure includes a sidewall extending vertically towards the bottom end of the side lining from the step surface.

12. The vehicle of claim 7 further including a plurality of seats arranged inside the passenger compartment and disposed in a plurality of rows including a rear row, wherein one or more seats of the rear row is configured to move between an upright position and a folded position.

13. The vehicle of claim 12, wherein the plurality of rows includes three rows and the one or more seats of the rear row separates the passenger compartment from the cargo area when arranged in the upright position, and the one or more seats of the rear row is moved to the folded position to extend the cargo area of the vehicle to accommodate a relatively large cargo.

14. The vehicle of claim 12, wherein the step surface is arranged at a vertical gap from a surface of the one or more seats arranged in the folded position.

15. A side lining for a vehicle and adapted to be mounted to a sidewall of the vehicle, the side lining comprising:
a first step structure defining a first step surface portion surface extending horizontally and inside a passenger compartment of the vehicle, wherein the first step surface portion is arranged proximate to a first longitudinal end of the side lining, and
a second step structure defining a second step surface portion extending horizontally and inside the passenger compartment of the vehicle, wherein the second step surface portion is arranged proximate to a rear end of the vehicle and is separated from the first step structure by a gap, wherein the first step surface portion and the second step surface portion are arranged proximate to a bottom end of the side lining and together define a load surface to support a cargo.

16. The side lining of claim 15, wherein the side lining is configured to extend from the rear end of the vehicle towards a front end of the vehicle along the sidewall of the vehicle.

17. The side lining of claim 15, wherein the first step surface portion aligns horizontally with the second step surface portion.

18. The side lining of claim 15, wherein each of the first step structure and the second structure includes a sidewall extending vertically towards the bottom end of the side lining from the first step surface portion and the second step surface portion, respectively.

19. The side lining of claim 15, wherein the vehicle includes one or more seats disposed inside the passenger compartment and adapted to be arranged in an upright position and a folded position, wherein the load surface is adapted to be arranged at a vertical gap from a surface of the one or more seats arranged in the folded position.

20. The side lining of claim 19, wherein the one or more seats are arranged in rear row of a plurality of rows of seats of the vehicle.
